(19) United States
(12) Patent Application Publication
(10) Pub. No.: US 2010/0014938 A1
(43) Pub. Date: Jan. 21, 2010

(54) THREAD LOCK FOR A THREADED CONNECTION

(76) Inventor: Rainer Sussenbach, Steinhagen (DE)

Correspondence Address: SEYFARTH SHAW LLP, 131 S. DEARBORN ST., SUITE 2400, CHICAGO, IL, 60603-5803, US

(21) Appl. No.: 12/527,239

(22) PCT Filed: Jan. 2, 2008
(86) PCT No.: PCT/EP08/00015

§ 371 Date: Aug. 14, 2009

(30) Foreign Application Priority Data
Feb. 16, 2007 (DE) 20 2007 002 347.2

(51) Int. Cl. F16B 39/30

(52) U.S. Cl. 411/309

(57) ABSTRACT

Thread lock for a threaded connection between a nut body composed of plastic with a nut thread and a bolt with a bolt thread, of which the bolt thread is a standard outer thread of a specified tolerance class with a degree of tolerance and a tolerance zone position, and the nut thread is modified compared to the standard inner thread assigned to the standard outer thread, such that
a) the maximum size of the outer diameter of the nut thread lies within the tolerance zone of the outer diameter of the bolt thread, and
b) the pitch of the nut thread is changed relative to the pitch of the bolt thread by such an amount that the deformation of the nut body created hereby remains within a permissible range.

### RELATED APPLICATION

This application is a U.S. National Phase of International Patent Application Serial No. PCT/EP2008/000015, filed Jan. 2, 2008 which claims priority to German Patent Application No. 20 2007 002 347.2 filed Feb. 16, 2007.

### BACKGROUND OF THE INVENTION

The present invention relates to a screw lock for a threaded connection between a threaded bolt and a nut body composed of plastic.

A thread lock of a threaded connection between a bolt and a nut body composed of metallic materials is attained in a customary manner in that the bolt is loaded by an appropriate fastening torque with an axial preload force, and the elastic stretch of the bolt resulting from this acts as a spring tension force.

For bolted connections with dissimilar material pairing, in which, for example, the bolt is composed of steel and the nut body of plastic, this type of thread lock is not possible:
The high fastening torque for the axial preload force of the bolt would destroy the plastic of the nut body.
If the fastening torque is adjusted to the plastic of the nut body this leads to a deformation exclusively of the nut body; the consequence is an increased stress only in the initial thread turns, while the remaining turns are unloaded.
The increased stress and the deformation resulting from it in the region of the initial thread turns leads to the fact that the plastic reaches the limits of its strength properties very quickly. This in turn reduces the amount of the torque that the bolted connection can bear, or the tensile load in the bolted connection.
No thread lock results because the stress acting in the initial thread turns during alternating thermal loading tends towards zero due to a relaxation of the plastic, such that the threaded connection is loosened with further alternating loading.

### SUMMARY OF THE INVENTION

The objective of the present invention is to develop a thread lock for a threaded connection between a nut body and a bolt of dissimilar material pairing, which is attained by a preload uniformly distributed over the nut threads in the axial and radial direction, and a resulting elastic deformation of the nut body, and which persists also during alternating stress loading, in particular, alternating thermal loading of the bolted connection.

This objective is solved by the threaded lock defined in Claim 1.

According to the invention, the nut thread of the nut body is modified relative to a standardized internal thread such that
a) the maximum size of the outer diameter of the nut thread lies within the tolerance zone of the outer diameter of the standardized bolt thread, and
b) the pitch of the nut thread is changed relative to the pitch of the bolt thread by such an amount that the deformation of the nut body generated hereby remains within a permissible range.

Due to the pitch offset between the nut thread and the bolt thread, an elastic deformation of the nut body in the area of the nut thread results during screwing the bolt into the nut body—after approximately the second or third thread turn. Through this, a corresponding compressive stress in the axial direction is exerted on the thread flanks of the nut body, while simultaneously the nut body is radially expanded in the area of the nut thread. Because the maximum of the outer diameter of the modified nut thread lies within, preferably in the middle of, the tolerance zone of the outer diameter of the bolt thread, and thus is offset radially inward with respect to the bolt thread, an optimal overlap of the thread flanks of the bolt and the nut body is attained despite the radial expansion of the nut body.

Thus, due to the modified nut thread, a preload is created in the threaded connection in the axial direction as well as in the radial direction. Even though the preload acting on the nut body and the deformation of the nut body caused by this lies in the permissible range, the fastening torque, and thus, the preload of the bolted connection can be selected to be relatively high, because the stress of the nut body is distributed evenly over the entire length of the nut thread. This leads to an optimal thread lock which is maintained even during rescrewings and alternating stress loadings, in particular, alternating thermal loads.

In a further embodiment of the invention, it is provided that the diameters of the flanks, the core diameter and the outer diameter of the nut thread each have a reduced degree of tolerance, relative to the corresponding diameter of the standardized inner thread. Through this, it is guaranteed that the thread flanks of the nut body and bolt come into contact with each other after the second or third thread turn at the latest, in order to distribute the loading of the threaded connection onto essentially the entire length of the threaded connection.

The bolt is preferably produced from metallic material, in particular, steel, whereas the nut body is produced from a technical high performance plastic of high temperature resistance, high rigidity, and high strength with low moisture absorption.

Further advantageous embodiments and further developments of the invention arise from the dependent claims.

### BRIEF DESCRIPTION OF THE DRAWINGS

Further details of the invention are explained in more detail based on the drawings. They show:

FIG. 1 a nut body composed of plastic in the form of a threaded insert with a modified nut thread;

FIG. 2 a sectional representation, corresponding to FIG. 1, of a modified exemplary embodiment of the threaded insert;

FIG. 3 a schematic representation of a part of a threaded connection between a bolt thread and nut thread in the form of metric ISO threads according to DIN 13;

FIG. 4 a representation, corresponding to FIG. 3, of a threaded connection with modified nut thread according to the invention;

FIG. 5 a half-section of the threaded insert, shown in FIG. 1, within a plastic support member before screwing in a bolt (not shown);

FIG. 6 a representation corresponding to FIG. 5 of the threaded insert after screwing in the bolt (not shown);

FIG. 7 a schematic representation of the thread deformation between the bolt thread and the nut thread in the area of approximately the tenth thread turn in the unscrewed state;

FIG. 8 a representation corresponding to FIG. 7 in the screwed-in state;

FIG. 9 a representation corresponding to FIG. 8 without considering the friction.

### DETAILED DESCRIPTION OF PREFERRED EXEMPLARY EMBODIMENTS

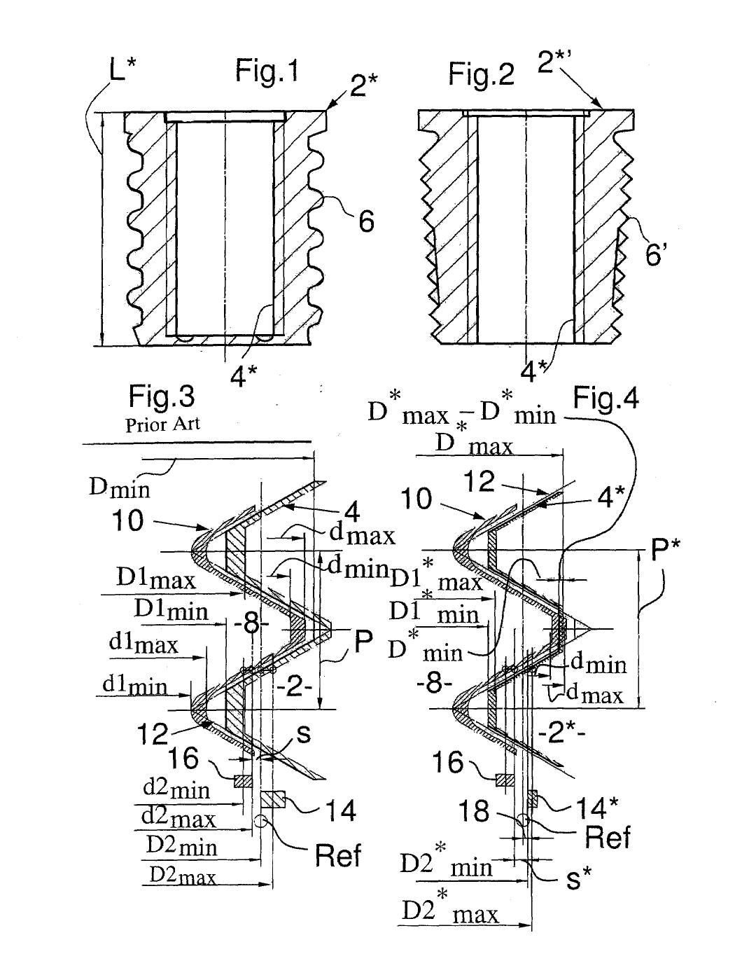

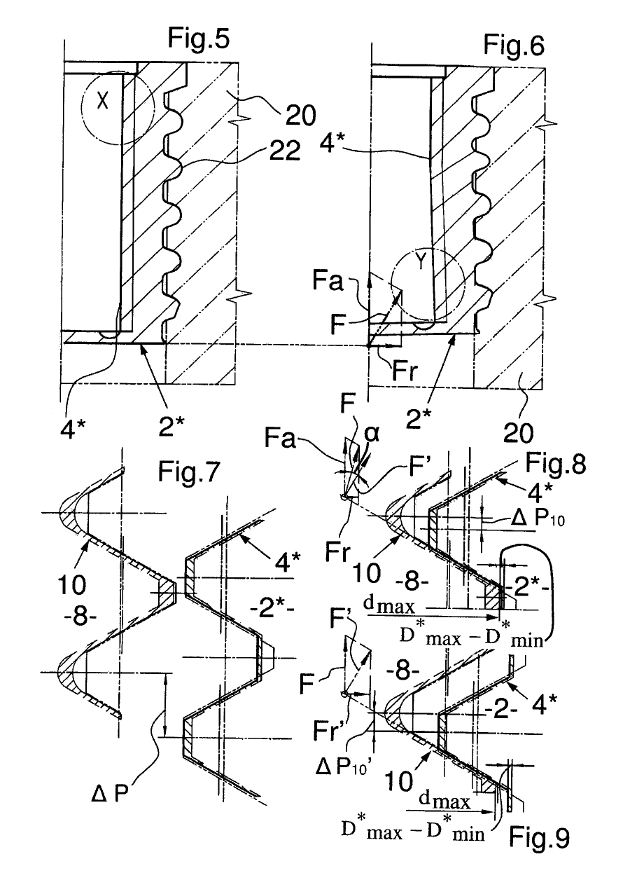

FIG. 1 shows a nut body 2* in the form of a threaded insert composed of plastic. The nut body 2* is provided with a nut thread 4* that is modified with respect to a standardized inner thread, as is explained in the following in more detail. In the represented exemplary embodiment, the nut body 2* is provided with a self-tapping outer thread 6, with which it can be screwed into a plastic support member (see FIGS. 5 and 6).

The nut body 2* represented in FIG. 2 is different from the nut body 2* in FIG. 1 solely in that instead of the self-tapping outer thread 6, it is provided with a saw tooth-like outer thread 6′, with which the threaded insert can be thermally embedded into a plastic support member (not shown)—for example, using an ultrasonic welding method.

However, it should be pointed out that the nut body need not be constructed as a threaded insert, rather, the nut body can be constructed in an arbitrary manner, for example, as a nut, a housing part, a support member, etc.; it is essential to the invention only that it is provided with a modified nut thread according to the invention.

FIG. 3 shows the thread design of a conventional threaded connection between a nut body 2 with an inner thread 4 and a bolt 8 with an outer thread 10, which are designed as metric ISO threads according to DIN 13. For the tolerances of the threads 4 and 10 relative to the basic profile 12, the customary mechanical engineering combination of tolerance classes were selected, that is, the tolerance class 6H for the inner thread 4 and the tolerance class 6g for the outer thread 10. As is well known, the tolerance classes are designated with numbers and the tolerance zone position with letters, wherein upper case letters are used for the inner thread, and lower case letters are used for the outer thread. For further details, reference is made to the relevant standards, in particular, DIN 13-19, DIN 13-20, DIN ISO 965-1, among others.

As can be seen in FIG. 3, the hatched tolerance ranges represented in the Figure result from this combination of tolerance classes. For the inner thread 4 of the nut body 2, the smallest flank diameter D2ₘᵢₙ according to the tolerance zone position H equals the diameter of a reference line Ref (H-line), and the largest flank diameter D2ₘₐₓ results from the degree of tolerance 6, which is illustrated by the tolerance zone 14. Further represented in FIG. 3, are the largest and smallest core diameter D1ₘₐₓ or D1ₘᵢₙ, and the smallest outer diameter D2ₘᵢₙ for the inner thread 4 of the nut body 2.

With the outer diameter 10 of the bolt 8, the largest flank diameter d2ₘₐₓ according to the tolerance zone position g has a specified distance to the reference line Ref, whereby the thread play S is formed. The smallest flank diameter d2ₘᵢₙ is specified by the tolerance class 6, which is illustrated by the tolerance zone 16. Further in FIG. 3, the largest and smallest outer diameter dₘₐₓ and dₘᵢₙ, and the largest and smallest inner diameter d1ₘₐₓ and d1ₘᵢₙ, are indicated for the outer thread 10.

Further, the threads 4 and 10 in FIG. 3 are formed as standard threads according to ISO 261, by which standard a specific pitch P is specified. For further details of the thread pairing represented in FIG. 3, reference is made to the relevant standards.

### Modified Threaded Connection of FIG. 4

FIG. 4 shows a representation according to FIG. 3 of a threaded connection designed according to the invention, in which the nut thread 4* of the nut body 2* is modified compared to the inner thread 4 of the nut body 2 of FIG. 3, in order to provide a thread lock of the threaded connection.

In the threaded connection of FIG. 4, the outer thread 10 of the bolt 8 is identical to that of FIG. 3. This means that the outer thread 10 has the tolerance class 6g and the pitch P.

The nut thread 4* of the nut body 2* is modified compared to the standard inner thread 2 of the tolerance class 6H in FIG. 3, in the following ways:

### 1.) Flank Diameter

The flank diameter receives the new tolerance class 4F. Thus, the smallest diameter D2*ₘᵢₙ corresponding to the new tolerance zone position is larger compared to the standard smallest flank diameter D2ₘᵢₙ, which is indicated by the distance 18 to the H-line Ref. This in turn leads to a larger thread play S*. The smaller degree of tolerance 4 indicates a smaller tolerance zone 14* or a smaller tolerance.

### 2.) Minor Diameter

For the core diameter, the tolerance position H is maintained so that the smallest core diameter D1*ₘᵢₙ is equal to the standard smallest core diameter D1ₘᵢₙ. In contrast, the degree of tolerance of the core diameter is reduced, and preferably such that the tolerance D1*ₘₐₓ-D1*ₘᵢₙ is reduced to approximately ½ of the tolerance D1ₘₐₓ−D1ₘᵢₙ of the core diameter of the standard inner thread 4 in FIG. 3. The tolerance D1*ₘₐₓ−D1*ₘᵢₙ then amounts to approximately 0.1 mm.

### 3.) Outer Diameter

The outer diameter of the nut thread 4* is modified in such a way that the largest outer diameter D*ₘₐₓ lies within the tolerance zone dₘₐₓ−dₘᵢₙ of the bolt thread 10, and preferably in the middle of this tolerance zone. The tolerance D*ₘₐₓ−D*ₘᵢₙ of the outer diameter is significantly smaller than the tolerance dₘₐₓ−dₘᵢₙ of the outer diameter of the bolt thread according to FIG. 3, and preferably amounts to ¼ of the tolerance dₘₐₓ−dₘᵢₙ. In the represented exemplary embodiment the tolerance D*ₘₐₓ−D*ₘᵢₙ amounts to approximately 0.05 mm.

### 4.) Pitch

The pitch P* of the nut thread 4* is also modified compared to the pitch P of the standard inner thread 4, or of the bolt thread 10. In the exemplary embodiment, the pitch P* is larger than the pitch P; however, in principle, P* can also be smaller than P. The change of the pitch (pitch offset) is selected such that the deformation of the nut body 2* caused through the pitch offset is as large as possible, however, remains within the permissible range of the material of the nut body 2*.

The pitch offset is selected depending on the length of the nut thread 4*. In the preferred exemplary embodiment, in which the nut thread 4* has approximately ten thread turns, the modified pitch P* amounts to approximately 1.04 times the pitch P of the standard thread. Therefore, the length L* of the nut body 2*(FIG. 1) is larger by a corresponding amount than the length of a corresponding nut body 2 with standard inner thread 4. With a larger or smaller number of thread turns, the factor with which the pitch P is to be multiplied is selected correspondingly smaller or larger.

In FIG. 4, the pitch offset is not represented. However, the geometric and functional effect of the pitch offset is explained in more detail with the description of the mode of operation of the modified thread pairing in connection with the FIGS. 7 to 9.

### 5.) Material

As already mentioned, the nut body 2* is composed of plastic. Advantageously, it is produced from a technical high performance plastic with high temperature resistance, high rigidity and high strength with low water absorption.

Preferred materials are PPA-GF, PPS-GF, PEI-GF and PEEK-GF. However, other thermal high performance plastics can be used, for example, PA-highly glass filled, or the materials PA, PPA, PPS, PEI, PEEK, with a filler material reinforcement, such as glass fiber reinforced, carbon fiber reinforced, carbon fiber and glass fiber reinforced. The bolt 8 is advantageously composed of a metallic material, in particular, steel.

### 6.) Mode of Operation

FIG. 7 shows the pitch offset ΔP between the bolt thread 10 and the modified nut thread 4* in the area of approximately the tenth thread turn, wherein the threads are not in engagement with each other, and are located in the same radial plane in the area of the first thread turn. Due to the pitch offset ΔP, the modified nut thread 4* has a greater length than the standard inner thread 4 according to FIG. 3. This has the consequence that while screwing in the bolt 8, the nut body 2* is axially compressed and radially expanded, as is explained in more detail in the following.

When the bolt 8 with its bolt thread 10 is screwed into the nut thread 4* of the nut body 2*, in the area of the dot-dashed circle X in FIG. 5, at the latest after the second to third thread turn, the thread play S* (FIG. 4) is overcome, so that the flanks of the bolt thread and the nut thread come into contact with each other. This is guaranteed, as already mentioned, by the reduced degree of tolerance (tolerance zone 14* in FIG. 4) of the flank diameter, as well as the reduced degree of tolerance of the core diameter and outer diameter of the nut thread 4*.

With further screwing in of the bolt thread 10 into the nut thread 4*, the bolt thread 10 exerts a force in the axial direction onto the flanks of the nut thread 4*. Due to the incline of the flanks (flank angle 30°) the bolt thread 10 also exerts a radial force onto the flanks of the nut thread 4*, whereby the nut body 2 is expanded radially. This is illustrated with a force diagram in FIG. 6, in which Fₐ represents the axial force component, Fᵣ represents the radial force component and F represents the force, which is acting in the perpendicular direction on the corresponding flank of the nut thread 4*.

FIG. 8 shows this state for the approximately tenth thread turn, thus, in the area for the dot-dashed circle Y in FIG. 6. As represented in FIG. 6 in an exaggerated view, the length of the nut body 2* has become smaller due to the axially acting compressive stress, while the nut thread 4* in the area of the dot-dashed circle Y has expanded radially.

It is important here that the pitch offset ΔP was selected with regard to the material properties of the nut body 2* so that the maximum deformation of the nut body 2* in the axial as well as the radial direction remains within the permissible expansion range (elastic and reversible) of the nut body 2*. An important consideration here is that despite the radial expansion of the nut thread 4*, a maximum overlap exists between the thread flanks of the bolt thread 10 and the nut thread 4. This is attained in that the largest outer diameter D*ₘₐₓ of the nut thread 4* in the un-deformed state (FIG. 4) lies within the tolerance zone of the outer diameter of the bolt thread 10, and furthermore, the tolerance of the outer diameter of the nut thread 4* was restricted in the described manner.

The FIGS. 8 and 9 show the axial and radial deformation of the nut thread 4* in the area of the tenth thread turn (dot-dashed circle Y in FIG. 6), and there, in the one instance, considering the friction, and in the other, without considering the friction.

Without friction (FIG. 9), the nut thread 4* expands more strongly in the radial direction, which has the consequence of a corresponding pitch offset ΔP′₁₀ in the area of the tenth thread turn. This is also illustrated in the force diagram with the axial force Fₐ, the radial force F′ᵣ, and the force F′ acting perpendicularly on the thread flanks.

If, corresponding to the actual conditions, the friction over a friction angle α (FIG. 8) is considered, a smaller radial expansion of the nut thread 4* and a corresponding pitch offset ΔP₁₀ result. This in turn leads to the desired result of a maximum overlap of the thread flanks of the bolt and nut threads.

Due to the pitch offset and the remaining modifications of the nut thread 4*, a uniform load distribution results over the entire thread length of the threaded connection. Furthermore, because due to the modification of the nut thread 4* a maximum flank overlap of the threads is guaranteed, a relatively large fastening torque and a high tensile load, and resulting from that, a large preload are possible in the bolt connection, without leading to an over expansion of the material of the nut body 2* and a corresponding destruction or relaxation of the plastic. Therefore, the preload acting in the axial as well as in the radial direction ensures an optimal thread lock of the threaded connection.

If the threaded connection is subjected to an alternating thermal load, then due to the preload prevailing in the threaded connection, the temperature dependent length and diameter changes of the bolt 8 and the nut body 2* occur in the same direction. Furthermore, because the expansion coefficients of the materials of the bolt 8 and the nut body 2* are of a similar order of magnitude, the preload acting on the bolt connection remains, and thus, the thread lock is maintained in essentially the same amount also in the case of temperature changes.

This applies also for repeated screwing and other alternating loadings of the threaded connection. Furthermore, tests have shown that after multiple repeated screwings and/or alternating thermal loadings, the loosening torque of the bolt connection is not only maintained, but rather, can even become larger.

1. A thread lock for a threaded connection between a nut body composed of plastic with a nut thread and a bolt with a bolt thread, of which the bolt thread is a standard outer thread of a specified tolerance class with a degree of tolerance and a tolerance zone position, and the nut thread is modified compared to a standard inner thread assigned to the standard outer thread, such that
a) the maximum size of the outer diameter of the nut thread lies within the tolerance zone of the outer diameter of the bolt thread,
b) the pitch of the nut thread is changed relative to the pitch of the bolt thread by such an amount that the deformation of the nut body created hereby remains within a permissible range, and
c) the tolerance zone position of the flank diameter of the nut thread is offset relative to the tolerance zone position of the flank diameter of the standard inner thread in the sense of an enlargement of the thread play.

2. The thread lock according to claim 1, characterized in that the maximum size of the outer diameter of the nut thread lies in the middle of the tolerance zone of the outer diameter of the bolt thread.

3. The thread lock according to claim 1, characterized in that the outer diameter of the nut thread has a reduced degree of tolerance compared to the outer diameter of the standard inner thread.

4. The thread lock according to claim 3, characterized in that the tolerance of the outer diameter of the nut thread is reduced to approximately ¼ of the tolerance of the outer diameter of the standard inner thread.

5. The thread lock according to claim 1, characterized in that the flank diameter of the nut thread has a reduced degree of tolerance compared to the flank diameter of the standard inner thread.

6. The thread lock according to claim 5, characterized in that the degree of tolerance of the flank diameter of the nut thread is reduced by at least two degree of tolerance steps compared to the degree of tolerance of the flank diameter of the standard inner thread.

7. The thread lock according to claim 1, characterized in that the core diameter of the nut thread has a reduced degree of tolerance compared to the core diameter of the standard inner thread.

8. The thread lock according to claim 7, characterized in that the tolerance of the core diameter of the nut thread is reduced to approximately ½ of the tolerance of the core diameter of the standard inner thread.

9. The thread lock according to claim 1, characterized in that the tolerance zone position of the core diameter of the nut thread is the same as the tolerance zone position of the core diameter of the standard inner thread.

10. The thread lock according to claim 1, characterized in that the pitch of the nut thread is greater than the pitch of the bolt thread.

11. The thread lock according to claim 10, characterized in that the pitch of the nut thread amounts to roughly 1.04 times the bolt thread.

12. The thread lock according to claim 1, characterized in that the pitch of the nut thread is smaller than the pitch of the bolt thread.

13. The thread lock according to claim 1, characterized in that the tolerance class of the standard outer thread is 6g and the tolerance class of the standard inner thread is 6H.

14. The thread lock according to claim 1, characterized in that the nut body is produced from a technical high performance plastic of high temperature resistance, high rigidity and high strength with low water absorption.

15. The thread lock according to claim 14, characterized in that the nut body is produced from PPA-GF, PPS-GF, PEI-GF or PEEK-GF.

16. The thread lock according to claim 1, characterized in that the bolt is produced from a metallic material.

17. The thread lock according to claim 1, characterized in that the modified nut thread spans the entire thread length of the threaded connection.
